(19) United States
(12) Patent Application Publication
(10) Pub. No.: US 2023/0084529 A1
(43) Pub. Date: Mar. 16, 2023

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Akihiro NISHITANI, Mie (JP); Shunya TAKEUCHI, Mie (JP); Yutaka KOBAYASHI, Mie (JP)

(21) Appl. No.: 17/909,116

(22) PCT Filed: Feb. 15, 2021
(86) PCT No.: PCT/JP2021/005440

§ 371 Date: Sep. 2, 2022

(30) Foreign Application Priority Data
Mar. 6, 2020 (JP) 2020-038710

(51) Int. Cl. H01R 13/426; H01R 4/28

(52) U.S. Cl. CPC H01R 13/426; H01R 4/28

(57) ABSTRACT

A connector is provided with a female housing into which a first conductor and a second conductor are insertable, a movable conductive member accommodated in the female housing and electrically contactable with the first conductor and the second conductor, a fixed conductive member electrically contactable with the first conductor and the second conductor, and a pressing member made of a resilient insulating material and accommodated in the female housing. The pressing member applies a pressing force in a contact direction to the movable conductive member, the fixed conductive member, the first conductor and the second conductor. The female housing is formed with positioning portions for positioning the first conductor and the second conductor in a width direction orthogonal to both axial directions of the first conductor and the second conductor and a pressing direction of the pressing member.

### TECHNICAL FIELD

The present disclosure relates to a connector.

### BACKGROUND

Patent Document 1 discloses a female terminal formed, such as by bending an electrically conductive metal plate. The female terminal includes a box-shaped electrical contact portion, into which a male terminal is inserted, in a front part and a pair of conductor crimping pieces in the form of an open barrel in a rear part. The conductor crimping pieces are fixed by being crimped to a conductor exposed by stripping a coating of a coated wire.

Patent Document 2 discloses a female connector provided with a female terminal fitting, first and second obliquely wound coil springs and a female housing for holding the both obliquely wound coil springs. The both obliquely wound coil springs are coiled by winding a wire material made of electrically conductive metal a plurality of times. The female terminal fitting is in the form of a flat plate and a core wire is connected to one end part thereof.

The female terminal fitting is accommodated into the female housing while being sandwiched by the two obliquely wound coil springs. When the female connector is connected to a mating male connector, the first obliquely wound coil spring is sandwiched between a wall surface (contact wall) in the female housing and the female terminal fitting and the second obliquely wound coil spring is sandwiched between a male terminal fitting provided in the male connector and the female terminal fitting. At this time, the second obliquely wound coil spring contacts the female terminal fitting and a terminal connecting portion and the female terminal fitting and the male terminal fitting are electrically connected by resilient restoring forces of the both obliquely wound coil springs. Further, the first obliquely wound coil spring is arranged to press the female terminal fitting toward the core wire.

### PRIOR ART DOCUMENT

### Patent Document

Patent Document 1: JP 2014-241219 A

Patent Document 2: JP 2019-046760 A

### SUMMARY OF THE INVENTION

### Problems to be Solved

In the case of Patent Document 1, a step of crimping the conductor crimping pieces to the conductor is necessary. In the case of Patent Document 2, the connector tends to be enlarged since the second obliquely wound coil spring is interposed between the male terminal fitting provided in the male connector and the female terminal fitting.

A connector of the present disclosure was completed on the basis of the above situation and aims to enable a crimping step to be omitted without enlargement.

### Means to Solve the Problem

The present disclosure is directed to a connector with a housing, a conductor being insertable into the housing, a conductive member accommodated in the housing, the conductive member being electrically contactable with the conductor, and a pressing member made of a resilient insulating material, the pressing member being accommodated in the housing, wherein the pressing member applies a pressing force in a contact direction to the conductive member and the conductor inserted into the housing, and the housing is formed with a positioning portion for positioning the conductor in a width direction orthogonal to both an axial direction of the conductor and a pressing direction of the pressing member.

Effect of the Invention

According to the present disclosure, a crimping step can be omitted without enlargement.

### BRIEF DESCRIPTION OF THE DRAWINGS

FIG. 1 is an exploded perspective view of a female connector constituting a connector of a first embodiment.

FIG. 2 is an exploded perspective view of a male connector constituting the connector.

FIG. 3 is a side view in section showing a state where a first conductor is connected to a movable conductive member and a fixed conductive member.

FIG. 4 is a section along X-X of FIG. 3.

FIG. 5 is a front view showing a state where a front member is removed from a housing body.

FIG. 6 is a partial enlarged front view of FIG. 5.

FIG. 7 is a side view in section showing a state where the first conductor and a second conductor are connected.

FIG. 8 is a front view showing a state where a front member is removed from a housing body in a second embodiment.

### DETAILED DESCRIPTION TO EXECUTE THE INVENTION

[Description of Embodiments of Present Disclosure]

First, embodiments of the present disclosure are listed and described.

(1) The connector of the present disclosure is provided with a housing, a conductor being insertable into the housing, a conductive member accommodated in the housing, the conductive member being electrically contactable with the conductor, and a pressing member made of a resilient insulating material, the pressing member being accommodated in the housing, wherein the pressing member applies a pressing force in a contact direction to the conductive member and the conductor inserted into the housing, and the housing is formed with a positioning portion for positioning the conductor in a width direction orthogonal to both an axial direction of the conductor and a pressing direction of the pressing member.

According to this configuration, since the conductive member and the conductor contact each other by the resilient pressing force in the contact direction applied from the pressing member, a step of crimping the conductor and the conductive member is unnecessary. Since the pressing member is made of the insulating material and it is not necessary to provide a structure for insulation separately from the pressing member, the enlargement of the connector can be avoided. Therefore, the crimping step can be omitted without enlarging the connector of the present disclosure. Since the conductor is positioned by the positioning portion, there is a little possibility that the conductor deviates from the conductive member, and contact reliability is excellent.

(2) Preferably, a region on a side opposite to the conductor and the conductive member in a direction of applying the pressing force, out of an outer surface of the pressing member, serves as an inclined surface symmetrically inclined with respect to the width direction, and the housing is formed with a receiving surface to be brought into surface contact with the inclined surface. According to this configuration, a reaction force acting on the pressing member from the conductor side when the pressing member applies the pressing force to the conductor and the conductive member acts on the receiving surface from the inclined surface. Since the inclined surface is symmetrically inclined with respect to the width direction, the pressing member can be prevented from being shifted in the width direction and inclined in the width direction.

(3) Preferably, the housing is formed with an anchor portion configured such that the pressing member is resiliently fittable thereinto. According to this configuration, the pressing member is resiliently deformed and fit into the anchor portion when applying the pressing force to the conductor and the conductive member. By this fitting, a position shift of the pressing member is prevented.

(4) Preferably, in (3), the anchor portion is formed by recessing a facing surface of the housing facing the pressing member, and a clearance is secured between an outer surface of the pressing member and an inner surface of the anchor portion in a state where the conductor is not inserted into the housing yet. If an anchor portion is projection-like, the pressing member rides on the projection-like anchor portion when the conductor is not inserted yet, and a contact area of the pressing member and the housing becomes relatively narrow. Thus, there is a concern that the position and posture of the pressing member become unstable. In contrast, if the anchor portion is recessed, the pressing member and the housing are in contact over a relatively wide area when the conductor is not inserted into the housing yet and the pressing member is not resiliently deformed. Therefore, there is a little possibility that the position and posture of the pressing member become unstable.

(5) Preferably, in (3) or (4), the anchor portion is arranged at a position on a side opposite to the conductor across the pressing member. According to this configuration, since the anchor portion is located on a line of action of the reaction force on the pressing member from the conductor side, a fitting force of the pressing member into the anchor portion is large and a position shift of the pressing member can be satisfactorily prevented.

(6) Preferably, a contact region of the conductive member with the conductor is constituted by an arcuate surface. According to this configuration, if the conductor has a circular cross-sectional shape like a wire or the like, a contact area of the conductive member and the conductor increases, wherefore a contact state of the conductive member and the conductor is stabilized.

[Details of Embodiments of Present Disclosure]

### First Embodiment

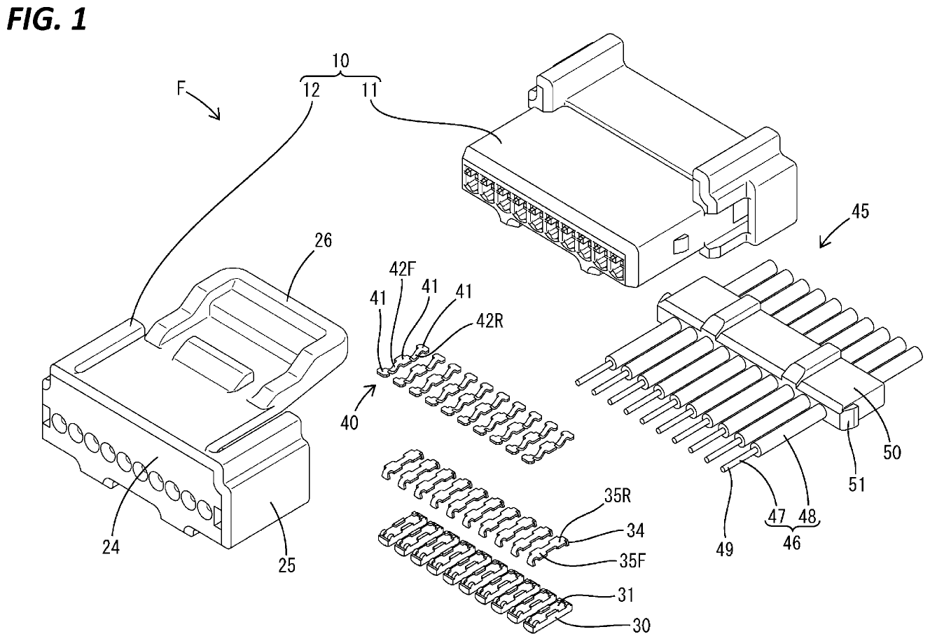

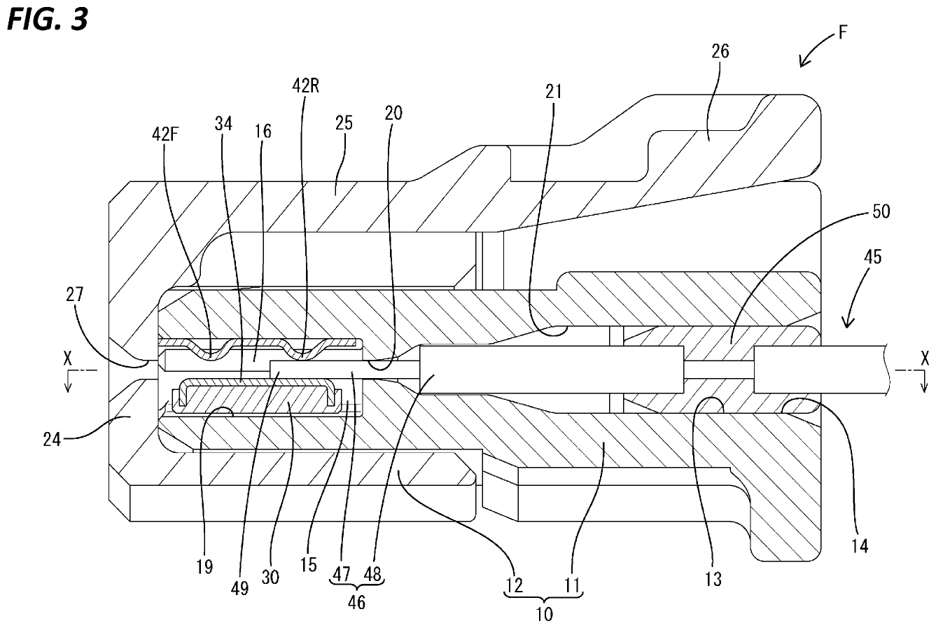

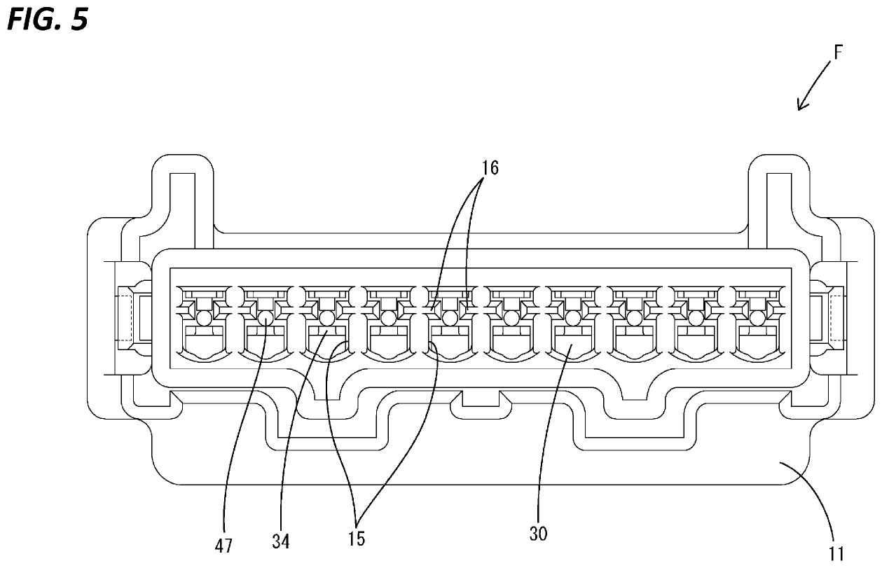

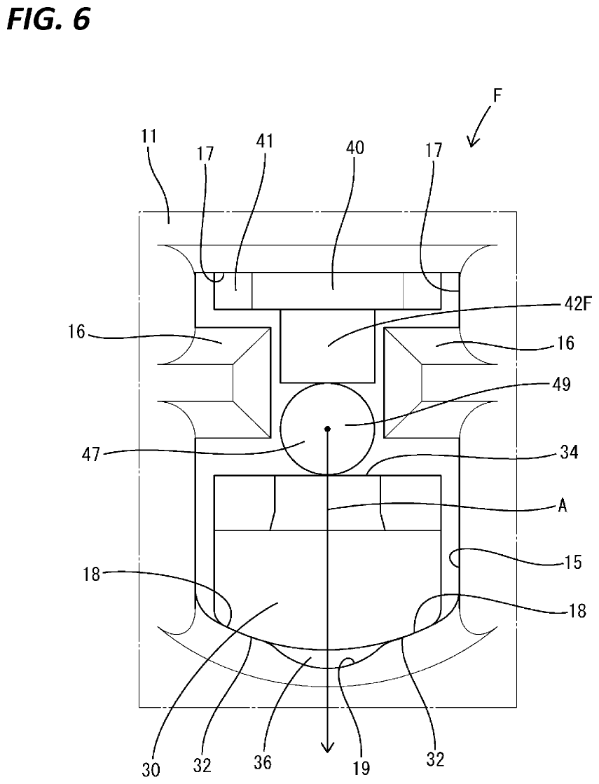

A specific first embodiment of a connector of the present disclosure is described below with reference to FIGS. 1 to 7. Note that the present invention is not limited to these illustrations and is intended to be represented by claims and include all changes in the scope of claims and in the meaning and scope of equivalents. In the first embodiment, a left side in FIGS. 3, 4 and 7 is defined as a front side concerning a front-rear direction. Upper and lower sides shown in FIGS. 1 to 3 and 5 to 7 are directly defined as upper and lower sides concerning a vertical direction. Left and right sides shown in FIGS. 5 and 6 are directly defined as left and right sides concerning a lateral direction. The lateral direction and a width direction are used as synonyms.

The connector of the first embodiment includes a female connector F and a male connector M to be connected to each other. The female connector F includes one female housing 10, a plurality of pressing members 30, a plurality of movable conductive members 34, a plurality of fixed conductive members 40 and one first wire module 45. The male connector M includes one male housing 60 and one second wire module 65.

The female housing 10 is made of a synthetic resin material and includes, as shown in FIGS. 3, 4 and 7, a housing body 11 and a front member 12 mounted on the housing body 11 from front. The housing body 11 includes a plurality of cavities 13 arranged in parallel in the lateral direction and one holding space 14 open in the rear end surface of the housing body 11.

The cavity 13 constitutes a space elongated in the front-rear direction as a whole. A front end part of the cavity 13 functions as a connecting portion 15 open in the front end surface of the housing body 11. The inside of the connecting portion 15 functions as a connection space for connecting a first conductor 47 and a second conductor 67.

As shown in FIG. 6, the connecting portion 15 has a bilaterally symmetrical shape in a front view of the connecting portion 15. The connecting portion 15 is formed with a pair of bilaterally symmetrical positioning portions 16. The pair of positioning portions 16 are formed to project inward in the width direction from both left and right inner wall surfaces of the connecting portion 15. The positioning portions 16 are arranged at positions above a center of the connecting portion 15 in the vertical direction.

A pair of bilaterally symmetrical groove portions 17 extending in the front-rear direction are formed in upper end parts of the inner side surfaces of the connecting portion 15, i.e. regions above the positioning portions 16. The groove portions 17 are open in the front end surface of the housing body 11. An interval between the projecting ends of the both left and right positioning portions 16 is set equal to or slightly larger than outer diameters of the first and second conductors 47, 67 to be described later.

The bottom surface of the connecting portion 15 is formed with a pair of bilaterally symmetrical receiving surfaces 18. In a front view, the receiving surface 18 is inclined to be gradually lower toward a widthwise center of the bottom surface. Although the receiving surface 18 is an arcuately curved surface, the receiving surface 18 may be a flat surface. An anchor portion 19 is formed in a widthwise central part of the bottom surface. The anchor portion 19 is arcuately recessed further downward than virtual extension planes (not shown) formed by extending the both left and right receiving surfaces 18 toward a widthwise central side.

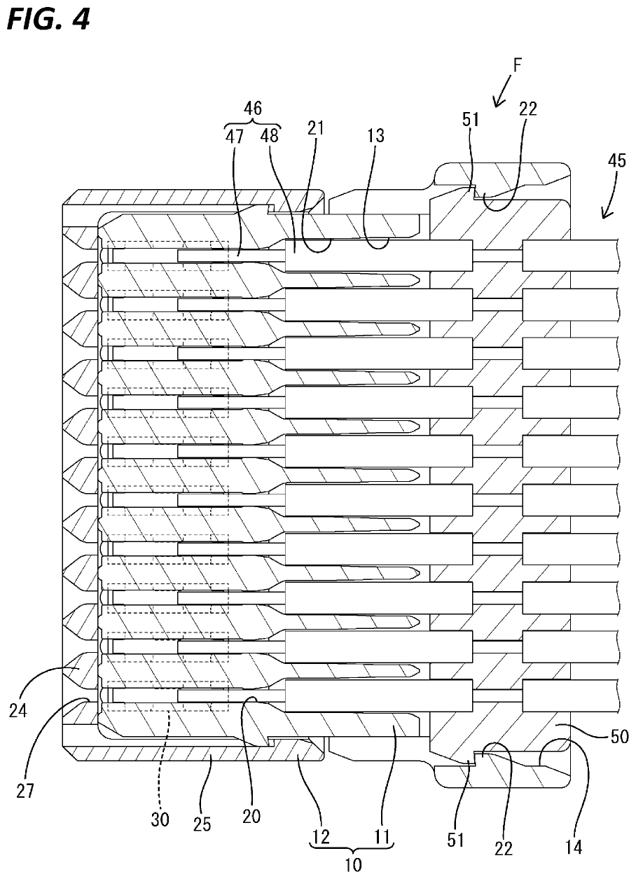

As shown in FIGS. 3 and 4, a region of the cavity 13 connected to the rear end of the connecting portion 15 functions as a guide portion 20 including a guide hole having a smaller diameter than the connecting portion 15. A region of the cavity 13 from the rear end of the guide portion 20 to the rear end of the cavity 13 functions as an insertion portion 21 having a larger diameter than the guide portion 20. The holding space 14 is in the form of a slit long in the lateral direction in the rear end surface of the housing body 11. The holding space 14 communicates with the rear ends of all the plurality of cavities 13 (insertion portions 21). A pair of left and right retaining projections 22 are formed in both left and right end parts of the holding space 14.

The front member 12 is in the form of a cap and includes, as shown in FIGS. 3 and 4, a front wall portion 24 for covering the front surface of the housing body 11, a peripheral wall portion 25 for surrounding a front end side region of the housing body 11 and a lock arm 26 extending rearward from the front wall portion 24 and constituting a part of the peripheral wall portion 25. Openings on the front ends of the plurality of connecting portions 15 are covered by the front wall portion 24. A plurality of insertion holes 27 penetrating through the front wall portion 24 in the front-rear direction are formed at a plurality of positions of the front wall portion 24 corresponding to the respective cavities 13 (connecting portions 15). Each insertion hole 27 has a circular cross-sectional shape having a smaller diameter than the connecting portion 15.

The plurality of pressing members 30 are made of an electrically insulating rubber material and can be resiliently deformed. The plurality of pressing members 30 are individually accommodated in the plurality of connecting portions 15. The pressing members 30 are arranged while being placed on the bottom surfaces of the connecting portions 15. The pressing member 30 is a single component having a rectangular parallelepiped shape long in the front-rear direction as a whole. A maximum width of the pressing member 30 is set larger than the interval between the projecting ends of the pair of positioning portions 16.

As shown in FIG. 1, an accommodation recess 31 for accommodating the movable conductive member 34 to be described later is formed in the upper surface of the pressing member 30. As shown in FIG. 6, the lower surface of the pressing member 30 has a pair of bilaterally symmetrical inclined surfaces 32 inclined to be gradually lower toward a widthwise center in a front view, similarly to the receiving surfaces 18 of the connecting portion 15. The lower surface of the pressing member 30 is arcuately curved with the same curvature as the receiving surfaces 18.

The movable conductive member 34 is, for example, made of a plate material made of metal such as copper or aluminum and shaped to be long in the front-rear direction as a whole. The movable conductive member 34 is a single component including a first conductive portion 35R and a second conductive portion 35F arranged forward of the first conductive portion 35R. The movable conductive member 34 is fixed to the pressing member 30 to be put on the upper surface of the pressing member 30.

With the movable conductive member 34 mounted on the pressing member 30, the upper surface of the movable conductive member 34 and the upper surface of the pressing member 30 are continuous and flush at the same height. Widths of the first and second conductive portions 35R, 35F are equal to that of the pressing member 30. The widths of the pressing member 30, the first conductive portion 35R and the second conductive portion 35F are set larger than the interval between the projecting ends of the pair of positioning portions 16.

As shown in FIG. 6, the movable conductive member 34 and the pressing member 30 are accommodated in a region of the connecting portion 15 below the positioning portions 16. With the pressing member 30 accommodated in the connecting portion 15, the inclined surfaces 32 of the pressing member 30 are closely held in surface contact with the receiving surfaces 18 of the connecting portion 15. Further, a clearance 36 is secured between the inclined surfaces 32 of the pressing member 30 and the inner surface of the anchor portion 19 in the anchor portion 19, out of the bottom surface of the connecting portion 15.

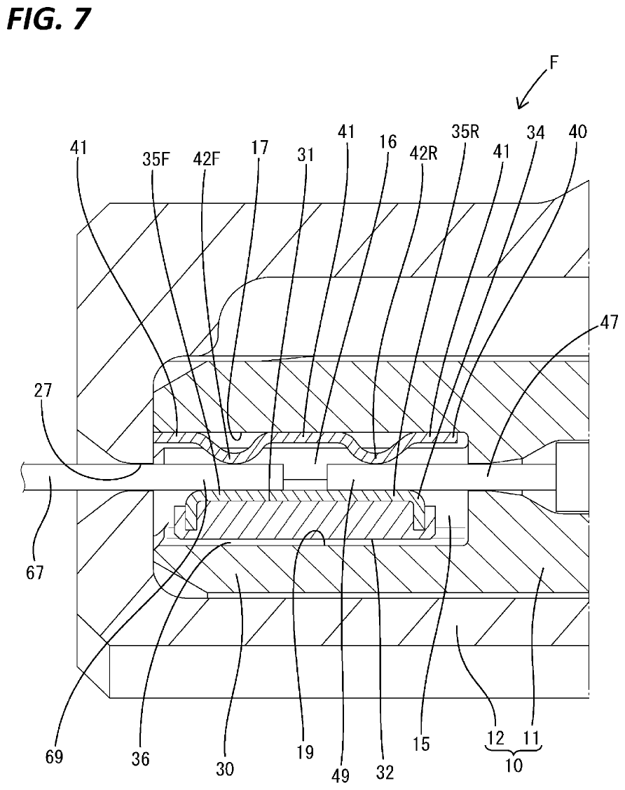

The fixed conductive member 40 is, for example, made of a plate material made of metal such as copper or aluminum, similarly to the movable conductive member 34. As shown in FIGS. 1 and 7, the fixed conductive member 40 is a single component including three mounting portions 41 arranged at intervals in the front-rear direction, a first contact point portion 42R and a second contact point portion 42F located forward of the first contact point portion 42R. The front and rear ends of the first contact point portion 42R are connected to the rear end of the mounting portion 41 located in a middle and the front end of the mounting portion 41 located on a rear side. The front and rear ends of the second contact point portion 42F are connected to the rear end of the mounting portion 41 located on a front side and the front end of the mounting portion 41 located in the middle. In a side view of the fixed conductive member 40, the first and second contact point portions 42R, 42F are curved to bulge downward and shaped to project further downward than the mounting portions 41.

The fixed conductive member 40 is fixedly mounted in an upper end part inside the connecting portion 15 by fitting both left and right end parts of the three mounting portions 41 into the groove portions 17 of the connecting portion 15. The fixed conductive member 40 is located above the pressing member 30 and the movable conductive member 34 and vertically facing the movable conductive member 34 across a predetermined interval. Vertical intervals between the lower ends of the first and second contact point portions 42R, 42F and the upper surface of the movable conductive member 34 in a state where the pressing member 30 is not resiliently deformed are set smaller than the outer diameters of the first and second conductors 47, 67 to be described later. Widths of the first and second contact point portions 42R, 42F are set smaller than the interval between the projecting ends of the pair of positioning portions 16. In a front view of the female connector F, the first and second contact point portions 42R, 42F are arranged between the pair of positioning portions 16.

The first wire module 45 is formed by integrating a plurality of first coated wires 46 and one first holding member 50. The first coated wire 46 is such that the first conductor 47 is surrounded with a first insulation coating 48. The first conductor 47 is constituted of a single core wire made of a metal material such as copper or aluminum and has rigidity to maintain a circular cross-sectional shape. The outer diameter of the first conductor 47 is set smaller than the widths of the first and second conductive portions 35R, 35F and smaller than the interval between the projecting ends of the pair of positioning portions 16. In an end part of the first coated wire 46, the first insulation coating 48 is removed to expose the first conductor 47. An exposed part of the first conductor 47 is defined as a first connecting end portion 49.

As shown in FIG. 1, the first holding member 50 has a flat shape extending in the width direction and collectively holds intermediate stripped parts of the plurality of first coated wires 46 laterally arranged side by side. The first holding member 50 is a molded article formed by covering the plurality of first coated wires 46 with resin. The plurality of first coated wires 46 are passed through the first holding member 50 in the front-rear direction and held while being positioned at fixed intervals in the lateral direction. A pair of left and right locking projections 51 are formed on both left and right side surfaces of the first holding member 50.

The first wire module 45 is assembled into the housing body 11 from behind the female housing 10. With the first wire module 45 assembled in the female housing 10, the locking projections 51 of the first holding member 50 are locked to the retaining projections 22 of the female housing 10, whereby the first wire module 45 is retained and held with respect to the female housing 10.

In an assembling process, the first connecting end portions 49 of the plurality of first conductors 47 are successively passed through the insertion portions 21 and the guide portions 20, enter the connecting portions 15 and are sandwiched between the first conductive portions 35R and the first contact point portions 42R. Since an interval between the first conductive portion 35R and the first contact point portion 42R is smaller than an outer diameter of the first connecting end portion 49, the first conductive portion 35R is displaced downward while resiliently deforming and squeezing the pressing member 30. The first conductor 47 and the first conductive portion 35R are conductively connected with a predetermined contact pressure and the first conductor 47 and the first contact point portion 42R are conductively connected with a predetermined contact pressure by a resilient restoring force of the pressing member 30.

Since being accommodated between the pair of positioning portions 16, the first conductor 47 is prevented from being shifted in the width direction with respect to the movable conductive member 34 and the fixed conductive member 40. In this way, the first conductor 47 and the movable conductive member 34 are stably connected and the first conductor 47 and the fixed conductive member 40 are also stably connected.

Further, with the first conductor 47, the movable conductive member 34 and the fixed conductive member 40 connected, a pressing force applied to the first conductor 47 from the side of the pressing member 30 acts as a reaction force on the pressing member 30 from the first conductor 47. Since the first conductor 47 is positioned in the widthwise central part of the connecting portion 15 by the positioning portions 16, a line of action A of the reaction force from the first conductor 47 passes through the widthwise central part of the bottom surface of the connecting portion 15, i.e. the anchor portion 19. Therefore, a part of a lower end part of the pressing member 30 bites into the anchor portion 19 while being resiliently deformed by the reaction force acting on the pressing member 30 from the first conductor 47. By this biting, the pressing member 30 is prevented from being shifted in the width direction.

Further, the inclined surfaces 32 of the pressing member 30 are pressed against the receiving surfaces 18 of the connecting portion 15 by the reaction force acting on the pressing member 30 from the first conductor 47. Here, the inclined surfaces 32 and the receiving surfaces 18 are bilaterally symmetrically inclined to become lower toward the widthwise center. Therefore, there is no possibility that the pressing member 30 having received the reaction force is inclined in the lateral direction.

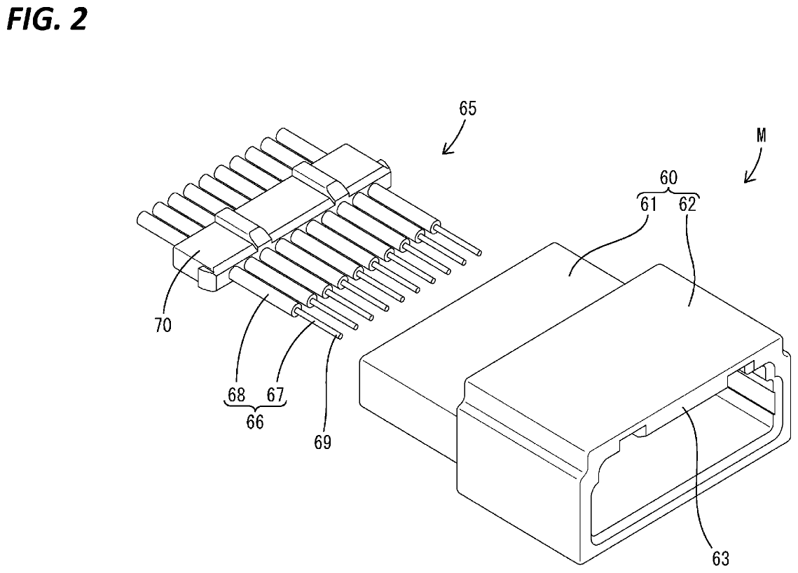

The male housing 60 of the male connector M is a single component made of synthetic resin and including, as shown in FIG. 2, a housing portion 61 and a tubular receptacle 62 projecting from the housing portion 61. A lock portion 63 to be locked to the lock arm 26 of the female connector F is formed on the inner surface of an upper wall part of the receptacle 62. Although not shown, the housing portion 61 includes a plurality of guide portions 20, a plurality of insertion portions 21 and a holding space 14 similar to the plurality of guide portions 20, the plurality of insertion portions 21 and the holding space 14 of the female connector F. The housing portion 61 does not have parts equivalent to the connecting portions 15 of the female connector F.

Similarly to the first wire module 45, the second wire module 65 is formed by integrating a plurality of second coated wires 66 and one second holding member 70. Similarly to the first coated wire 46, the second coated wire 66 is configured such that the second conductor 67 is surrounded with a second insulation coating 68. The second conductor 67 is constituted of a single core wire made of a metal material such as copper or aluminum and has rigidity to maintain a circular cross-sectional shape. The outer diameter of the second conductor 67 is set equal to that of the first conductor 47. In an end part of the second coated wire 66, the second insulation coating 68 is removed to expose the second conductor 67. An exposed part of the second conductor 67 is defined as a second connecting end portion 69.

The second wire module 65 is also assembled into the housing portion 61 by a configuration similar to that for the first wire module 45. With the second wire module 65 assembled in the male housing 60, the second connecting end portions 69 of the second conductors 67 project into the receptacle 62 from the front surface of the housing portion 61.

In connecting the male connector M and the female connector F, the female connector F is fit into the receptacle 62. In a connection process, the second connecting end portions 69 of the second conductors 67 enter the connecting portions 15 through the insertion holes 27 and are, as shown in FIG. 7, inserted between the second conductive portions 35F and the second contact point portions 42F. At this time, the second conductor 67 is positioned in the width direction by the pair of positioning portions 16. In this way, the second conductor 67 and the second conductive portion 35F are connected with a predetermined contact pressure by a resilient restoring force of the pressing member 30 and the second conductor 67 and the second contact point portion 42F are connected with a predetermined contact pressure by the resilient restoring force of the pressing member 30. Further, a reaction force acts on the pressing member 30 from the second conductor 67, but there is a little possibility that the pressing member 30 is inclined in the lateral direction or shifted in the lateral direction, as in the case of the first conductor 47.

The male connector M constituting the connector of the first embodiment includes the female housing 10, into which the first and second conductors 47, 67 are insertable, the movable conductive members 34, the fixed conductive members 40 and the pressing members 30. The movable conductive member 34 is accommodated in the female housing 10 and can electrically contact the first and second conductors 47, 67. The fixed conductive member 40 is also accommodated in the female housing 10 and can electrically contact the first and second conductors 47, 67. The pressing member 30 is made of the resilient insulating material and accommodated in the female housing 10. The pressing member 30 applies a pressing force in a contact direction to the movable conductive member 34 and the first and second conductors 47, 67 inserted into the female housing 10. The pressing member 30 applies the pressing force in the contact direction to the fixed conductive member 40 and the first and second conductors 47, 67 inserted into the female housing 10.

Since the movable conductive member 34 and the first conductor 47 contact each other by the resilient pressing force in the contact direction applied from the pressing member 30, a step of crimping the first conductor 47 and the movable conductive member 34 is unnecessary. Since the fixed conductive member 40 and the first conductor 47 also contact each other by the resilient pressing force in the contact direction applied from the pressing member 30, a step of crimping the first conductor 47 and the fixed conductive member 40 is unnecessary.

Since the pressing member 30 is made of the insulating material and it is not necessary to provide a structure for insulation separately from the pressing member 30, it is realized to avoid the enlargement of the female connector F. Therefore, the crimping step can be omitted without enlarging the connector of the first embodiment.

The female housing 10 is formed with the positioning portions 16 for positioning the first and second conductors 47, 67 in the width direction orthogonal to both axial directions (front-rear direction) of the first and second conductors 47, 67 and the pressing direction (vertical direction) of the pressing member 30. Since the first and second conductors 47, 67 are positioned in the width direction by the positioning portions 16, the first and second conductors 47, 67 have a little possibility of deviating in the width direction with respect to the movable conductive member 34 and the fixed conductive member 40. Therefore, the contact reliability of the movable conductive member 34 and the fixed conductive member 40 with the first conductor 47 is excellent and the contact reliability of the movable conductive member 34 and the fixed conductive member 40 with the second conductor 67 is excellent.

Out of the outer surface of the pressing member 30, lower surface regions on a side opposite to an upper side toward which a pressing force is applied to the movable conductive member 34 and the fixed conductive member 40 serve as the inclined surfaces 32 inclined symmetrically with respect to the width direction. The female housing 10 is formed with the pair of left and right receiving surfaces 18, with which the pair of left and right inclined surfaces 32 are brought into surface contact. When the pressing member 30 applies a pressing force to the first and second conductors 47, 67, the movable conductive member 34 and the fixed conductive member 40, a reaction force acts on the pressing member 30 from the side of the first conductor 47 and the side of the second conductor 67, and this reaction force acts on the receiving surfaces 18 from the inclined surfaces 32. Since the pair of inclined surfaces 32 are inclined symmetrically with respect to the width direction, the pressing member 30 can be prevented from being shifted in the width direction and inclined in the width direction by receiving the reaction force.

The female housing 10 is formed with the anchor portion 19, into which the pressing member 30 can be resiliently fit. The pressing member 30 is resiliently deformed by the reaction force from the side of the first conductor 47 and the side of the second conductor 67 and fit into the anchor portion 19 when applying the pressing force to the first and second conductors 47, 67, the movable conductive member 34 and the fixed conductive member 40. By this fitting, a position shift of the pressing member 30 is prevented.

The anchor portion 19 is formed by recessing the facing surface (bottom surface) of the female housing 10 facing the lower surface of the pressing member 30. In a state where the first and second conductors 47, 67 are not inserted into the female housing 10 yet, the clearance 36 is secured between the lower surface (outer surface) of the pressing member 30 and the inner surface of the anchor portion 19. If an anchor portion is projection-like, the pressing member 30 rides on the projection-like anchor portion when the first and second conductors 47, 67 are not inserted into the female housing 10 yet. Thus, a contact area of the pressing member 30 and the female housing 10 becomes relatively narrow and there is a concern that the position and posture of the pressing member 30 become unstable. In contrast, since the anchor portion 19 is recessed in this embodiment, the inclined surfaces 32 of the pressing member 30 and the receiving surfaces 18 of the female housing 10 are in contact over a relatively wide area when the first and second conductors 47, 67 are not inserted into the female housing 10 yet. Therefore, there is a little possibility that the position and posture of the pressing member 30 become unstable.

The anchor portion 19 is arranged at a position on a side opposite to the first and second conductors 47, 67 across the pressing member 30. According to this configuration, since the anchor portion 19 is located on the line of action A of the reaction force on the pressing member 30 from the side of the first conductor 47 and the side of the second conductor 67, a fitting force of the pressing member 30 into the anchor portion 19 is large. In this way, the pressing member 30 can be satisfactorily prevented from being shifted in the width direction.

### Second Embodiment

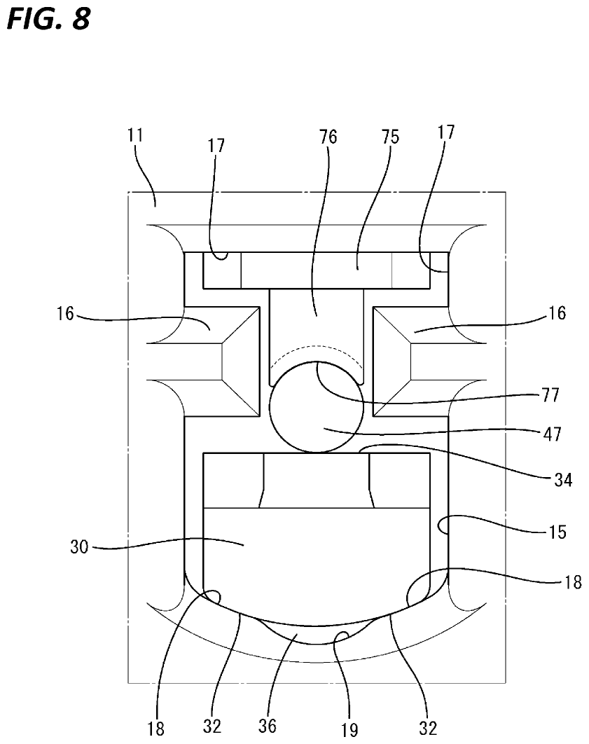

A second specific embodiment of the present disclosure is described with reference to FIG. 8. A connector of the second embodiment is different in configuration from the first embodiment in two front and rear contact point portions 76 provided in a fixed conductive member 75. Since the other configuration is the same as in the first embodiment, the same components are denoted by the same reference signs and the structures, functions and effects thereof are not described.

Since first and second conductors 47, 67 have a circular cross-sectional shape, contact regions of the contact point portions 76 of the fixed conductive member 75 with the first and second conductors 47, 67 are constituted by arcuate surfaces 77 to be brought into surface contact with the outer peripheral surfaces of the first and second conductors 47, 67. According to this configuration, a contact area of the fixed conductive member 75 and the first conductor 47 is increased and a contact area of the fixed conductive member 75 and the second conductor 67 is increased. In this way, a contact state of the fixed conductive member 75 and the first conductor 47 is stabilized and a contact state of the fixed conductive member 75 and the second conductor 67 is stabilized. Further, the positions of the first and second conductors 47, 67 are stabilized in a width direction.

### Other Embodiments

The present invention is not limited to the above described and illustrated embodiments and is represented by claims. The present invention is intended to include all changes in the scope of claims and in the meaning and scope of equivalents and also include the following embodiments.

Although the anchor portion is recessed in the above embodiments, the anchor portion may be projection-like.

Although the inclined surfaces are so symmetrically inclined that the widthwise central part protrudes in the above first and second embodiments, the inclined surfaces may be so symmetrically inclined that the widthwise central part is recessed.

Although the regions on the side opposite to the conductors and the conductive members in the pressing force applying direction, out of the outer surface of the pressing member, serve as the inclined surfaces in the above first and second embodiments, these regions may be flat surfaces perpendicular to the pressing force applying direction to the conductors and the conductive members.

Although the housing is formed with the anchor portion in the above first and second embodiments, the housing may include no anchor portion.

Although the anchor portion is arranged at the position on the side opposite to the conductors across the pressing member and located on the line of action of the reaction force on the pressing member from the conductor side in the above first and second embodiments, the anchor portion may be arranged at a position deviated from the line of action of the reaction force on the pressing member from the conductor side.

Although the movable conductive member and the fixed conductive member are brought into contact with the conductors in the above first and second embodiments, only the movable conductive member may be brought into contact with the conductors without providing the fixed conductive member or only the fixed conductive member may be brought into contact with the conductors without providing the movable conductive member.

In the above first and second embodiments, a pressing member and a movable conductive member may be provided instead of the fixed conductive member and a pair of the movable conductive members may be resiliently brought into contact with two conductors by resilient forces of a pair of the pressing members.

Although only the fixed conductive member is formed with the arcuate surfaces in the above second embodiment, the arcuate surfaces may be formed on both the fixed conductive member and the movable conductive member or may be formed only on the movable conductive member.

Although the movable conductive member is a plate-like member made of metal such as copper or aluminum in the above first and second embodiments, the movable conductive member may be a linear member or rod-like member made of metal or may be a conductive member made of a metal foil of copper or aluminum, carbon powder, carbon nanotubes or the like and to be applied to the pressing member.

Although the pressing member is made of rubber in the above first and second embodiments, the material of the pressing member is not limited to rubber and may be a synthetic resin.

Although the conductor is a single core wire of the wire in the above first and second embodiments, the conductor is not limited to the single core wire and may be formed by solidifying a stranded wire by ultrasonic welding, laser welding or the like or may be a busbar made of a metal plate material.

In the above first and second embodiments, a connecting device may include, for example, a water stop member such as a heat shrinkable tube in addition to the movable conductive member, the fixed conductive member and the pressing member. The water stop member may be mounted to cover the conductor exposed between the pressing member and the insulation coating.

Although the plurality of fixed conductive members are arranged while being insulated from each other in the above first and second embodiments, the plurality of fixed conductive members may be integrally coupled via a coupling portion.

List of Reference Numerals

| | |
|---|---|
| 10 | female housing (housing) |
| 11 | housing body |
| 12 | front member |
| 13 | cavity |
| 14 | holding space |
| 15 | connecting portion |
| 16 | positioning portion |
| 17 | groove portion |
| 18 | receiving surface |
| 19 | anchor portion |
| 20 | guide portion |
| 21 | insertion portion |
| 22 | retaining projection |
| 24 | front wall portion |
| 25 | peripheral wall portion |
| 26 | lock arm |
| 27 | insertion hole |
| 30 | pressing member |
| 31 | accommodation recess |
| 32 | inclined surface |
| 34 | movable conductive member (conductive member) |
| 35F | second conductive portion |
| 35R | first conductive portion |
| 36 | clearance |
| 40 | fixed conductive member (conductive member) |
| 41 | mounting portion |
| 42F | second contact point portion |
| 42R | first contact point portion |
| 45 | first wire module |
| 46 | first coated wire |
| 47 | first conductor (conductor) |
| 48 | first insulation coating |
| 49 | first connecting end portion |
| 50 | first holding member |
| 51 | locking projection |
| 60 | male housing |
| 61 | housing portion |
| 62 | receptacle |
| 63 | lock portion |
| 65 | second wire module |
| 66 | second coated wire |
| 67 | second conductor (conductor) |
| 68 | second insulation coating |
| 69 | second connecting end portion |
| 70 | second holding member |
| 75 | fixed conductive member |
| 76 | contact point portion |
| 77 | arcuate surface |
| A | line of action |
| F | female connector |
| M | male connector |

What is claimed is:

1. A connector, comprising:
a housing, a conductor being insertable into the housing;
a conductive member accommodated in the housing, the conductive member being electrically contactable with the conductor; and
a pressing member made of a resilient insulating material, the pressing member being accommodated in the housing,
wherein:
the pressing member applies a pressing force in a contact direction to the conductive member and the conductor inserted into the housing,
the housing is formed with a positioning portion for positioning the conductor in a width direction orthogonal to both an axial direction of the conductor and a pressing direction of the pressing member; and
the conductor is a wire or busbar.

2. A connector, comprising:
a housing, a conductor being insertable into the housing;
a conductive member accommodated in the housing, the conductive member being electrically contactable with the conductor; and
a pressing member made of a resilient insulating material, the pressing member being accommodated in the housing,
wherein:
the pressing member applies a pressing force in a contact direction to the conductive member and the conductor inserted into the housing,
the housing is formed with a positioning portion for positioning the conductor in a width direction orthogonal to both an axial direction of the conductor and a pressing direction of the pressing member,
a region on a side opposite to the conductor and the conductive member in a direction of applying the pressing force, out of an outer surface of the pressing member, serves as an inclined surface symmetrically inclined with respect to the width direction, and
the housing is formed with a receiving surface to be brought into surface contact with the inclined surface.

3. A connector, comprising:
a housing, a conductor being insertable into the housing;
a conductive member accommodated in the housing, the conductive member being electrically contactable with the conductor; and
a pressing member made of a resilient insulating material, the pressing member being accommodated in the housing,
wherein:
the pressing member applies a pressing force in a contact direction to the conductive member and the conductor inserted into the housing,
the housing is formed with a positioning portion for positioning the conductor in a width direction orthogonal to both an axial direction of the conductor and a pressing direction of the pressing member, and
the housing is formed with an anchor portion configured such that the pressing member is resiliently fittable thereinto.

4. The connector of claim 3, wherein:
the anchor portion is formed by recessing a facing surface of the housing facing the pressing member, and
a clearance is secured between an outer surface of the pressing member and an inner surface of the anchor portion in a state where the conductor is not inserted into the housing yet.

5. The connector of claim 3 or 4, wherein the anchor portion is arranged at a position on a side opposite to the conductor across the pressing member.

6. The connector of any one of claims 1 to 5, wherein a contact region of the conductive member with the conductor is constituted by an arcuate surface.
